(19) United States
(12) Patent Application Publication
(10) Pub. No.: US 2026/0235175 A1
(43) Pub. Date: Aug. 13, 2026

(54) BRAKE HUB ASSEMBLY

(71) Applicant: GUNITE CORPORATION, Rockford, IL (US)

(72) Inventors: Yi GE, Vernon Hills, IL (US); Zachary Z. ZEBROVIOUS, Davis Junction, IL (US); Gregory Alan STURDY, Oakwood Village, OH (US); Pengchong LI, Vancouver, WA (US)

(21) Appl. No.: 19/149,465

(22) PCT Filed: Jan. 18, 2024
(86) PCT No.: PCT/US2024/012077

§ 371 Date: Jul. 18, 2025

Related U.S. Application Data
(60) Provisional application No. 63/480,810, filed on Jan. 20, 2023.

(51) Int. Cl. F16D 65/12; B60B 27/00; F16D 65/02

(52) U.S. Cl. CPC F16D 65/123; B60B 27/0052; F16D 2065/1356; F16D 2065/1392

(57) ABSTRACT

A brake hub assembly includes a hub having a first set of lugs extending radially outward away from the central axis and a second set of lugs, a wheel flange plate to which a wheel is securable, the wheel flange plate defining a first plurality of stud apertures and a set of flange plate lugs, a locking ring defining a second plurality of stud apertures and having a set of locking lugs that are configured to engage adjacent lugs of the first set of lugs of the brake hub and adjacent lugs of the set of flange plate lugs such that the first and second plurality of stud apertures are axially aligned, and a brake disk removably coupled to the second set of lugs. Each of the wheel flange plate and the brake disk is removable from the hub without removing the hub from the axle.

### CROSS-REFERENCE TO RELATED APPLICATIONS

This application claims priority to U.S. Provisional Application No. 63/480,810, filed Jan. 20, 2023, the entire contents of which are incorporated herein by reference.

### BACKGROUND OF THE INVENTION

Large vehicles such as commercial trucks (e.g., semi-trucks and trailers) can utilize drum brake or disk brake systems to provide the necessary braking. Typically, when a brake disk needs to be serviced or replaced, the user must first remove the hub assembly from the axle before the brake disk can be removed from the hub. However, alternative brake hub assemblies where the wheel flange plate and the brake disk are removable from the hub without removing the hub from the axle, such as that disclosed in U.S. Pat. No. 8,950,556, also exist.

### SUMMARY OF THE INVENTION

The invention provides, in one aspect, a brake hub assembly attachable to an axle of a vehicle. The brake hub assembly includes a hub defining a central axis, the hub having a first set of lugs extending radially outward away from the central axis and a second set of lugs axially spaced from the first set of lugs, a wheel flange plate to which a wheel is securable, the wheel flange plate defining a first plurality of stud apertures and a set of flange plate lugs, a locking ring defining a second plurality of stud apertures and having a set of locking lugs that are configured to engage adjacent lugs of the first set of lugs of the brake hub and adjacent lugs of the set of flange plate lugs such that the first and second plurality of stud apertures are axially aligned, and a brake disk removably coupled to the second set of lugs. The wheel flange plate is positioned axially between the first set of lugs and the second set of lugs. Each of the wheel flange plate and the brake disk is removable from the hub without removing the hub from the axle.

The invention provides, in another aspect, a method of assembling a brake hub assembly. The method includes inserting a brake disk in an axial direction over a first end of a hub, past a first set of lugs of the hub, and into engagement with a second set of lugs of the hub, fastening the brake disk to the hub, inserting a wheel flange plate over the first end of the hub and past the first set of lugs, rotating a set of flange plate lugs of the wheel flange plate relative to the hub such that the wheel flange plate is precluded from axial movement towards the first end of the hub, and inserting a locking ring over the first end of the hub such that locking lugs of the locking ring engage adjacent lugs of the first set of lugs of the hub and adjacent lugs of the set of flange plate lugs.

### BRIEF DESCRIPTION OF THE DRAWINGS

FIG. 1 is a perspective view of a brake hub assembly.

FIG. 2A is a perspective view of a hub of the brake hub assembly of FIG. 1.

FIG. 2B is a front view of the hub of the brake hub assembly of FIG. 1.

FIG. 3 is a perspective view of a brake disk of the brake hub assembly of FIG. 1.

FIG. 4 is a is a perspective view of a wheel flange plate of the brake hub assembly of FIG. 1.

FIG. 5 is a perspective view of the wheel flange plate with a plurality of studs mounted thereto.

FIG. 6 is a front perspective view of a locking ring of the brake hub assembly of FIG. 1.

FIG. 7 is a rear perspective view of the locking ring of the brake hub assembly of FIG. 1.

FIG. 8 is a rear perspective view of the wheel flange plate and locking ring coupled to one another.

FIG. 9 is a front perspective view of a cross-section of the brake hub assembly of FIG. 1.

FIG. 10 is a rear perspective view of the cross-section of the brake hub assembly of FIG. 1.

FIG. 11 is a perspective view of the brake hub assembly of FIG. 1 in a first state of assembly/disassembly with the brake disk mounted to the hub.

FIG. 12 is a perspective view of the brake hub assembly of FIG. 1 in a second state of assembly/disassembly with the wheel flange plate positioned on the hub.

FIG. 13 is a perspective view of the brake hub assembly of FIG. 1 in a third state of assembly/disassembly with the locking ring positioned on the hub.

FIGS. 14A-14F is an array of images illustrating a method of assembling the brake hub assembly of FIG. 1 and disassembling the brake hub assembly of FIG. 1 when taken in a reverse order.

FIG. 15 is a cross-sectional side view of a wheel positioned relative to the wheel.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

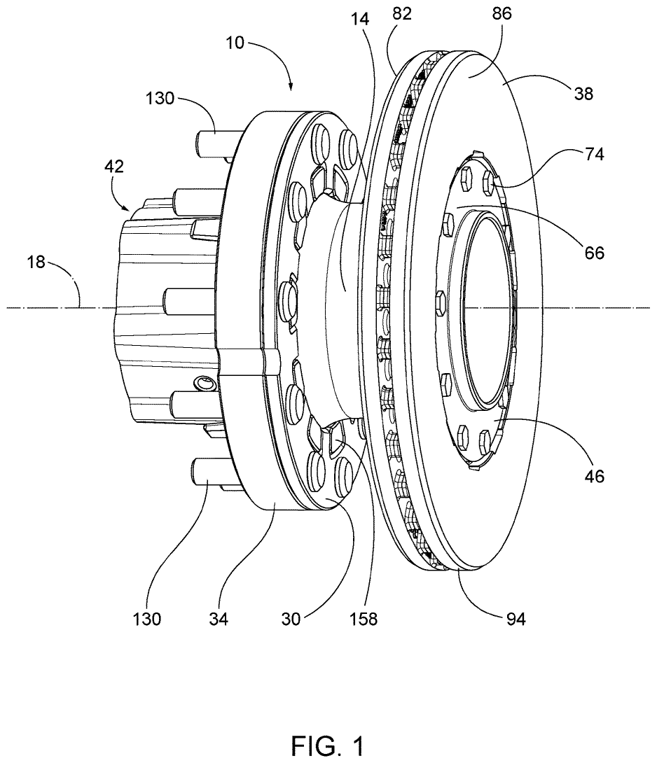

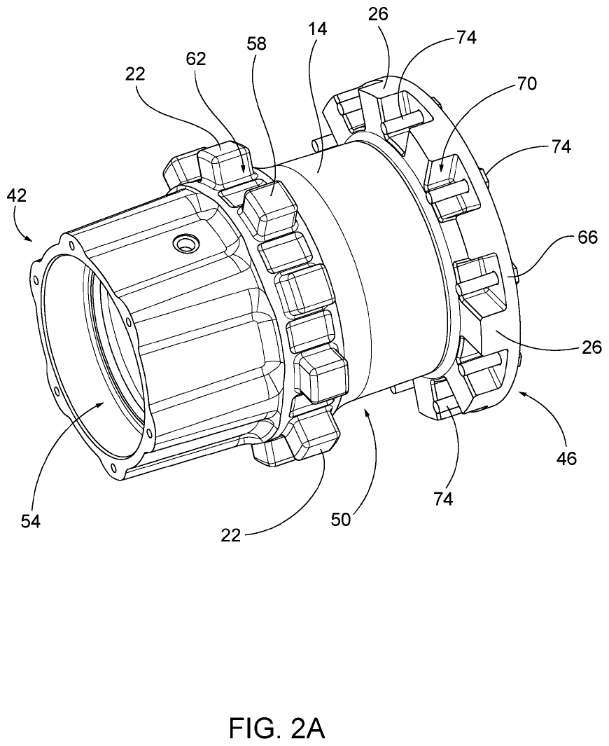

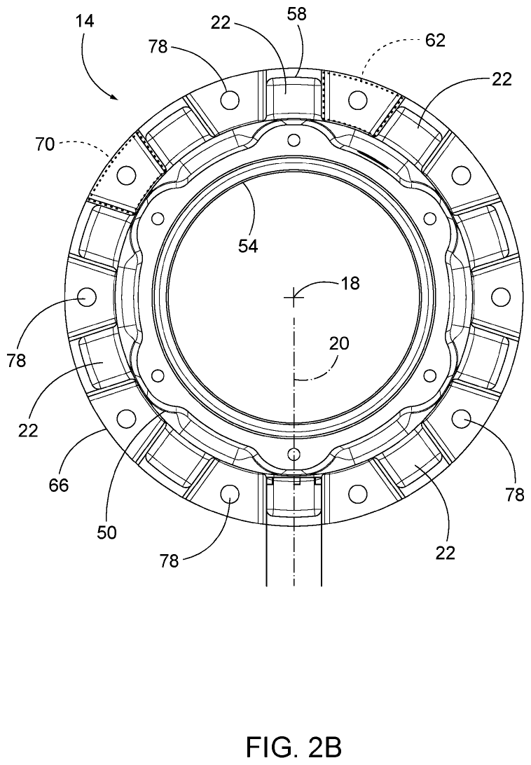

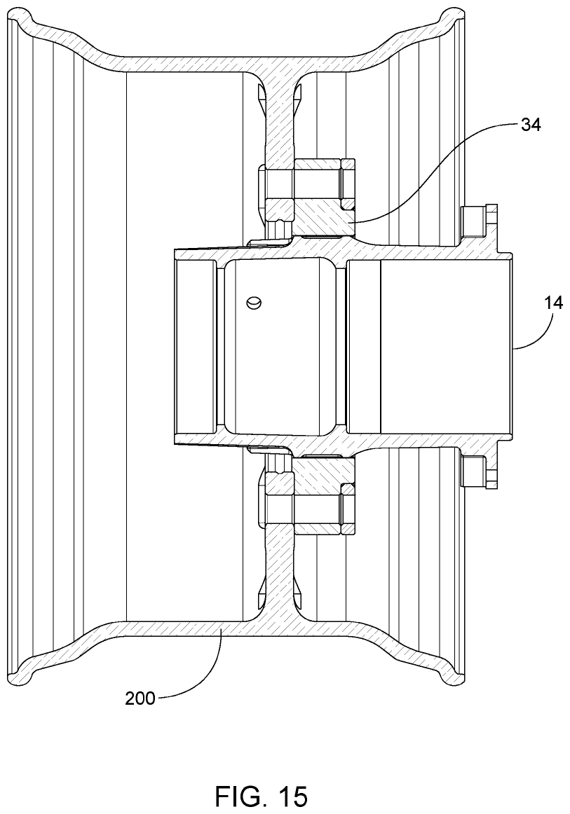

A brake hub assembly 10, as shown in FIG. 1, includes a hub 14 defining a central axis 18 and having first and second sets of lugs 22, 26, a wheel flange plate 30 to which a wheel 200 (FIG. 15) is securable (either directly or indirectly), a locking ring 34, and a brake disk 38 removably coupled to the hub 14. As shown in FIGS. 2A-2B, the hub 14 extends between a first (outer) distal end 42 and a second (inner) distal end 46. When mounted to an axle of a vehicle, the first distal end 42 is external, located adjacent the perimeter of the vehicle and further outward than the second distal end 46. The hub 14 is generally tubular between the first and second distal ends 42, 46, defining an outer surface 50 and an inner passageway 54 for the vehicle axle (not shown). The hub 14 supports the brake disc 38, the wheel flange plate 30, and the locking ring 34 thereon.

The hub 14 includes a first set of lugs 22 that extend radially outward from the generally cylindrical outer surface 50 of the hub 14. As shown, the lugs 22 are spaced equidistant from one another along a plane that is perpendicular to the central axis 18. As such, a distance between the first distal end 42 and each of the lugs 22 is substantially the same. The lugs 22 are positioned at a location central between the first and second distal ends 42, 46, nearer to a location equidistant between the two ends 42, 46 than either end 42, 46. In other embodiments, the lugs 22 may be located adjacent to and/or nearer to one of the two ends 42, 46.

In the embodiment shown, the first set of lugs 22 includes ten lugs 22 offset from one another by thirty-six degrees, though more of fewer (e.g., 4, 5, 6, 8, 12, 14, 16, 20) lugs may otherwise form the first set of lugs 22. In the embodiment shown in FIG. 2A, the number of lugs 22 corresponds to the number of lugs 98 of the brake disk 38 and to the number of fasteners 74 that couple the brake disk 38 to the hub 14. As shown in FIG. 2B, each lug 22 is a substantially rectangular prism, with each sidewall extending perpendicular to the central radial axis 20 of the lug 22. In other embodiments, each lug 22 form a trapezoidal prism, with each sidewall extending radially outward from the central axis 18. The shape of the lug 22 may deviate from a pure rectangular prism with a distal (radially outer) surface 58 (FIGS. 2A and 2B) of each lug 22 formed as a curved surface having a radius that extends from the central axis 18 to the distal surface 58. A gap 62 between each of the first lugs 22 is trapezoidal and extends between the sidewalls of adjacent lugs 22.

With continued reference to FIGS. 2A-2B, the hub 14 further includes a second set of lugs 26 located at or adjacent to the second distal end 46 of the hub 14. The second set of lugs 26 extend radially outward from the generally cylindrical outer surface 50 of the hub 14. The number of second lugs 26 matches (or otherwise exceeds) the number of first lugs 22 and the size (i.e., width) and shape (i.e., generally rectangular prism) of the second lugs 26 is substantially similar to the first lugs 22. In the embodiment shown, the second lugs 26 are radially aligned with the first lugs 22 and the gaps 62, 70 are likewise therefore radially aligned with one another. With the lugs 22, 26 and gaps 62, 70 radially aligned, moving the brake disk 38 axially over the hub 14 (e.g., during assembly or disassembly) does not necessitate rotation of the brake disk 38 relative to the hub 14 to seat the brake disk 38 on the hub 14. In other embodiments, the second lugs 26 may be radially offset from the first lugs 22.

The second set of lugs 26 are interconnected to one another via the generally cylindrical outer surface 50 of the hub 14 from which each lug 26 extends and also via a circular rotor flange 66 that extends radially outward from the outer surface 50 at the second distal end 46 of the hub 14. In some embodiments, the rotor flange 66 has a similar outer diameter (e.g., the same, ±10%) as each of the second set of lugs 26 and includes axially oriented through apertures 78 (FIG. 2B) extending through the rotor flange 66 at locations between each pair of lugs 26 (i.e., within the gap 70 defined between each adjacent lug). Each through hole 78 receives a fastener 74 (e.g., threaded fastener such as a bolt, a press/interference fit fastener) for fastening the brake disk 38 to the hub 14.

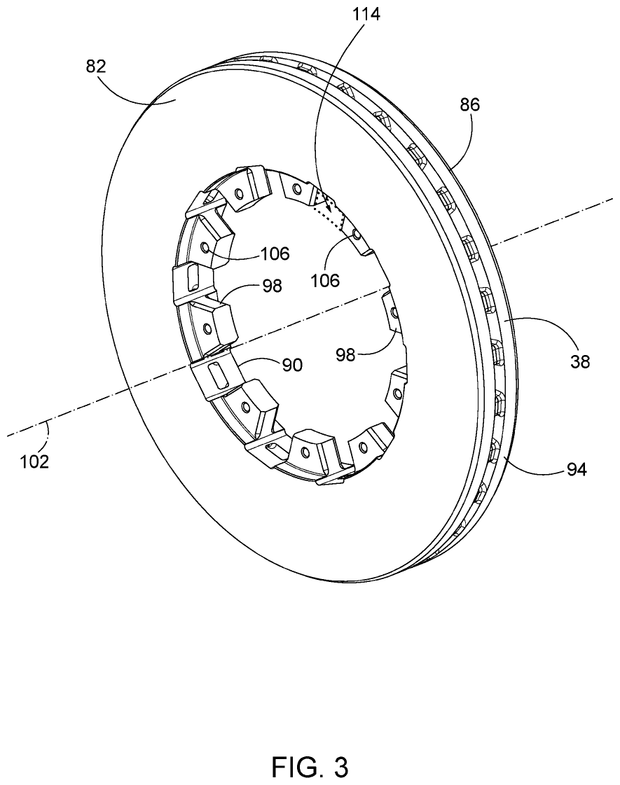

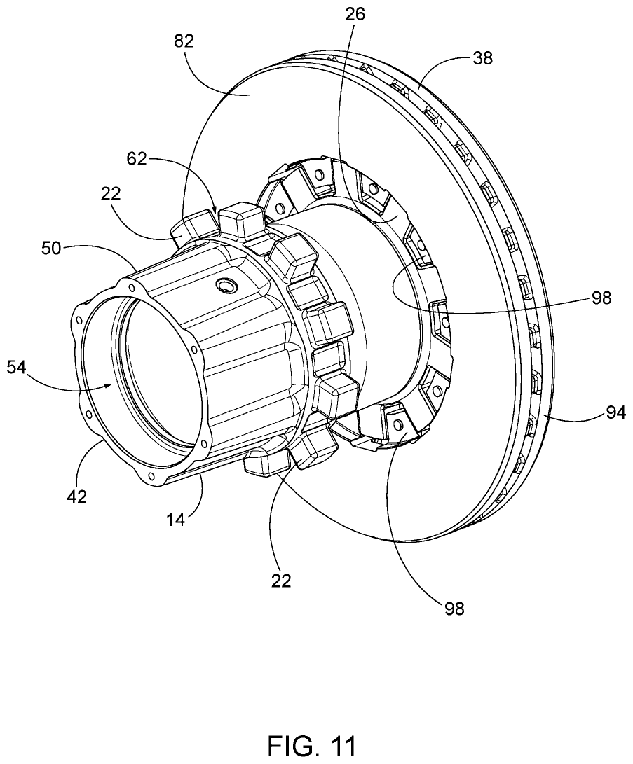

The brake disk 38 is shown in FIG. 3 includes two annular faces 82, 86 that are, in operation, engaged by brake pads (not shown) to provide braking for the vehicle having the brake hub assembly 10. The annular faces 82, 86 are substantially parallel to one another and are connected to one another. Each annular face 82, 86 defines a circular radially inner periphery 90 and a circular radially outer periphery 94. A plurality of brake disk lugs 98 extend radially inward from the radially inner periphery 90 towards a central axis 102 (the central axis 102 being coaxial with the central axis 18). The lugs 98 are substantially trapezoidal in shape, corresponding to the size and shape of the gap 70 and also corresponding to the size and shape of the gap 62. The trapezoidal shape of the lugs 98 includes a wider base at the circular radially inner periphery 90 and a narrower tip radially inward from there, with the width of each lug 98 decreasing from the base to the tip. In other embodiments, where the gaps 70 in the second set of lugs 26 correspond to other shapes (e.g., rectangular cross-section), the shape of the lugs 98 would likewise correspond to such shapes. The gaps 114 between the adjacent lugs 98 are generally the size and shape of the lugs 26 that form the second set of lugs 26 on the hub 14 (though larger by a reasonable tolerance to permit assembly) such that the lugs 26 fill the gaps 114, as shown in, for example, FIG. 11.

Each lug 98 includes an axially-extending through hole 106 that aligns with the through apertures 78 in the rotor flange 66 when the lugs 98 are positioned within the gaps 70 between the lugs 26 of the hub 14. The fasteners 74 extend through the respective through apertures 78 of the rotor flange 66 and into the through apertures 106 of the brake disk 38 to secure the brake disk 38 to the hub 14. In some embodiments, the fastener 74 is a threaded fastener and the through holes 106 are a threaded hole for engaging the fastener 74.

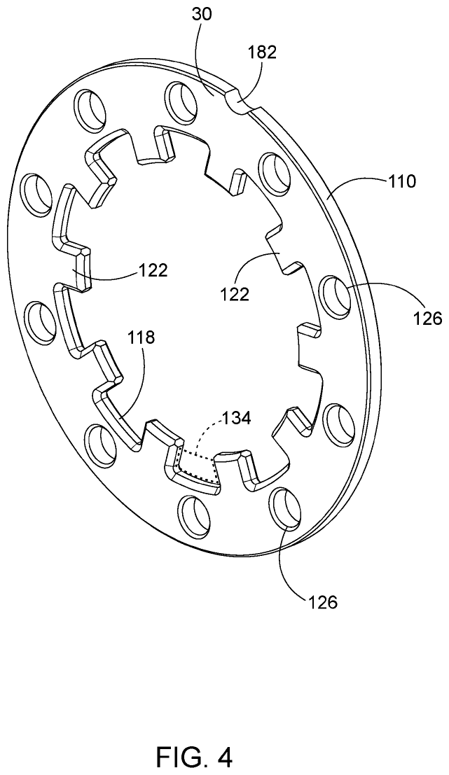

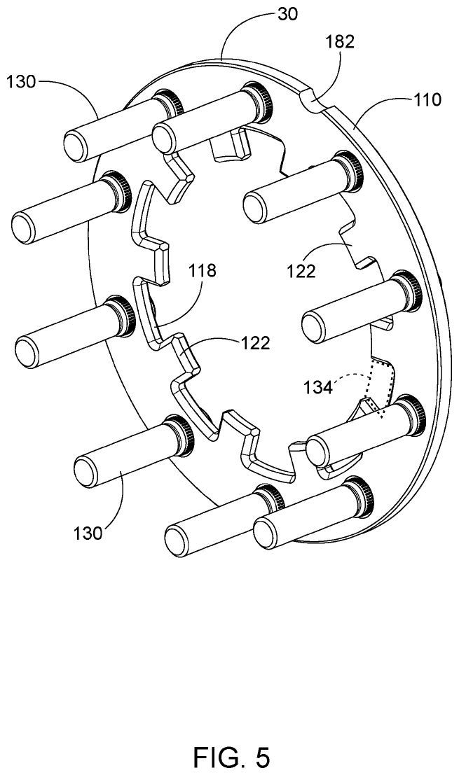

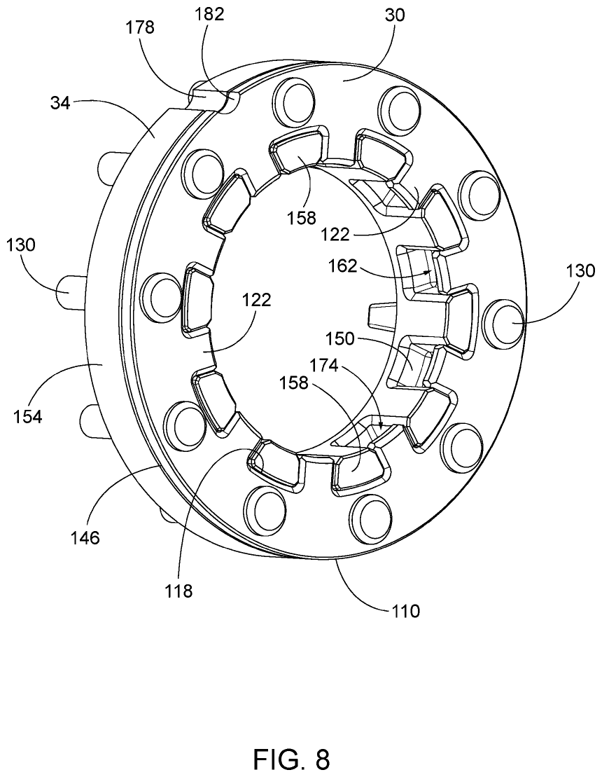

FIGS. 4-5 illustrate the wheel flange plate 30. The wheel flange plate 30 supports a wheel 200 (FIG. 15) on the hub 14 (with the locking ring 34 sandwiched therebetween), including studs 130 for mounting the wheel to the hub 14. The wheel flange plate 30 also indirectly couples the wheel to the axle (not shown) through the hub 14. As shown, the wheel flange plate 30 is an annular plate having a circular outer periphery 110 and a central opening 118 similar to that of the brake disk 38. The central opening 118 includes lugs 122 extending radially inward with a similar size, shape, quantity, and spacing as the lugs 98 of the brake disk 38 and are therefore sized to fit within the gaps 62 formed between each lug 22 of the first set of lugs. In some embodiments, the shape of the lugs 122 may be dissimilar from the shape of the lugs 98 of the brake disk 38, though still sized to fit within the gaps 62. The gaps 134 between each adjacent pair of lugs 122 also have a similar quantity and spacing as the gaps 114 in the brake disk 38. In some embodiments, the size and shape of the gaps 134 are similar to the gaps 114 in the brake disk 38 though in other embodiments, they may be dissimilar. The similarities between the lugs 98, 122 and gaps 114, 134 are based on how the lugs 98, 122 of both of the brake disk 38 and the wheel flange plate 30 pass through the gaps 62 within the first set of lugs 22 of the hub 14 during assembly and disassembly and therefore are limited in size, shape, quantity, and spacing to fit within those gaps 62. The wheel flange plate additionally includes axial stud apertures 126 extending through the flange plate 30 parallel to the central axis 18 (FIG. 1). As shown in FIG. 5, studs 130 are positioned within (e.g., inserted into, press fit in) the stud apertures 126 for mounting a wheel 200 (FIG. 15) to the flange plate 30. The number and arrangement of the stud apertures 126 and studs 130 may vary based on the bolt pattern for the wheel to be mounted to the hub assembly 10. In some embodiments, the studs 130 have a head (FIG. 8) larger than the diameter of the stud aperture 126 to engage the rear surface of the wheel flange plate 30, providing a hard stop for the stud 130.

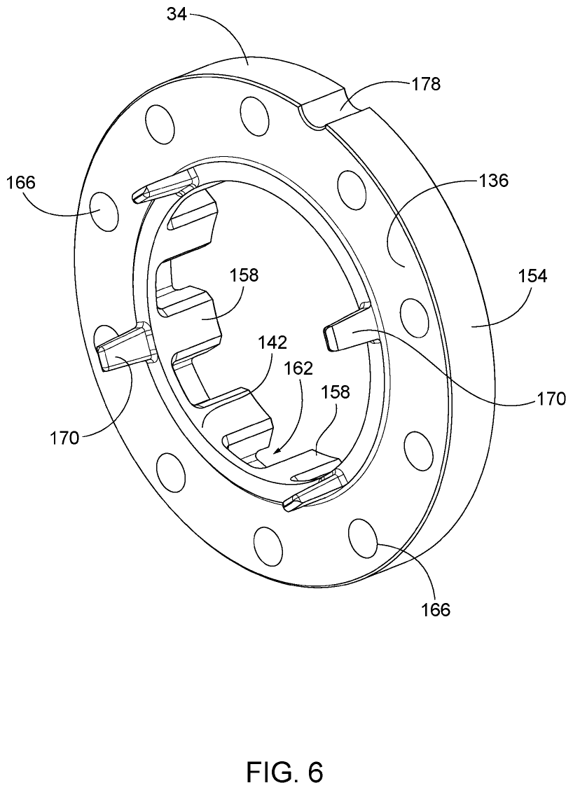

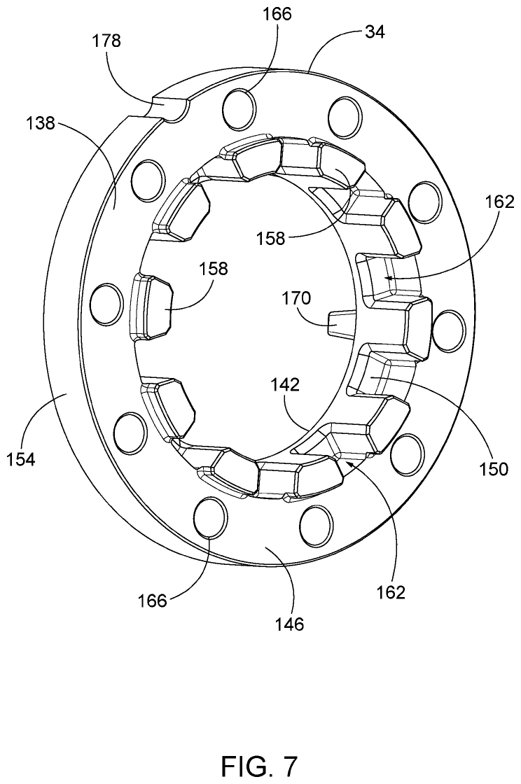

FIGS. 6-7 illustrate the locking ring 34 that prevents unwanted rotation of the wheel flange plate 30 relative to the hub 14 and assists in transmitting torque from the hub 14 to the wheel mounted to the studs 130. The locking ring 34 includes an outer face 136 (shown in FIG. 6) and an inner face 138 (shown in FIG. 7) opposite the outer face 136. The outer face 136 is substantially planar and is annular defining part of a central opening 142 that extends around the outer surface 50 of the hub 14. The inner face 138 is annular and includes an outer annular portion 146 that is axially offset from an inner annular portion 150. The inner annular portion 150 is located adjacent to the central opening 142 and defines a plurality of locking lugs 158 and gaps 162 between each adjacent locking lug 158. The gaps 162 form locking pockets that receive both of the lugs 22 of the hub 14 and the lugs 122 of the wheel flange plate 30. The thickness of the locking ring 34 at the central opening 142 (not including the thickness of the locking lugs 158) is less than the thickness at an outer periphery 154 of the locking ring 34 as the outer face 136 is located nearer to the inner annular portion 150 than the outer annular portion 146. The gaps 162 are therefore at least partially formed as locking pockets defined by the transition between the outer and inner annular portions 146, 150.

The locking lugs 158 of the locking ring 34 extend radially inward from the transition between the outer and inner annular portions 146, 150 and extend axially from the inner annular portion 150 away from the outer face 136. In some embodiments, the locking lugs 158 extend axially to the outer annular portion 150 of the inner face 138 and in some embodiments, the locking lugs 158 extend axially past the outer annular portion 150 to define an axially rearmost portion of the locking ring 34. When assembled, the locking lugs 158 extend through the gaps 134 defined between the adjacent lugs 122 of the wheel flange plate 30 and through the gaps 62 defined between the adjacent lugs 22 of the hub 14. As such, the locking lugs 158 are sized similar to or at least smaller than the gaps 62, 134 (by a reasonable tolerance to permit assembly) in a plane perpendicular to the axial direction (i.e., the assembly direction of the locking ring 34).

The locking ring 34 further includes stud apertures 166 through the locking ring 34 parallel to the central axis 18 and axially aligned with respective stud apertures 126 in the wheel flange plate 30 when assembled. When aligned, each stud 130 passes through one of the apertures 126 in the wheel flange plate 30 and one of the apertures 166 in the locking ring. The locking ring also includes four protrusions 170 extending axially outward from the outer face 136 adjacent the central opening 142. The four protrusions 170 are spaced equidistantly from one another along the edge of the central opening 142 and are formed as thin tabs having a length (extending in the axial direction) greater than their width or thickness. The protrusions 170 function as pilots to guide the wheel during installation such that the wheel is centered about the central axis 18 of the hub and the axle.

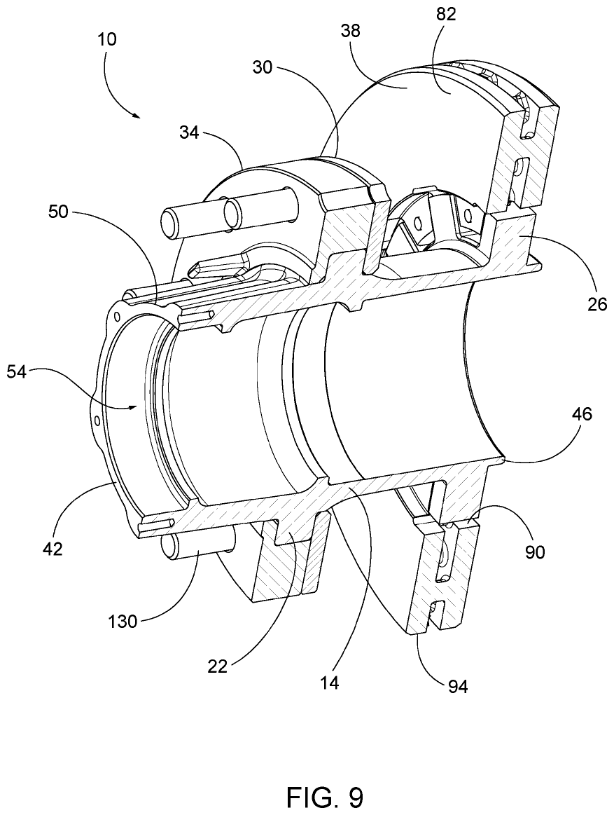

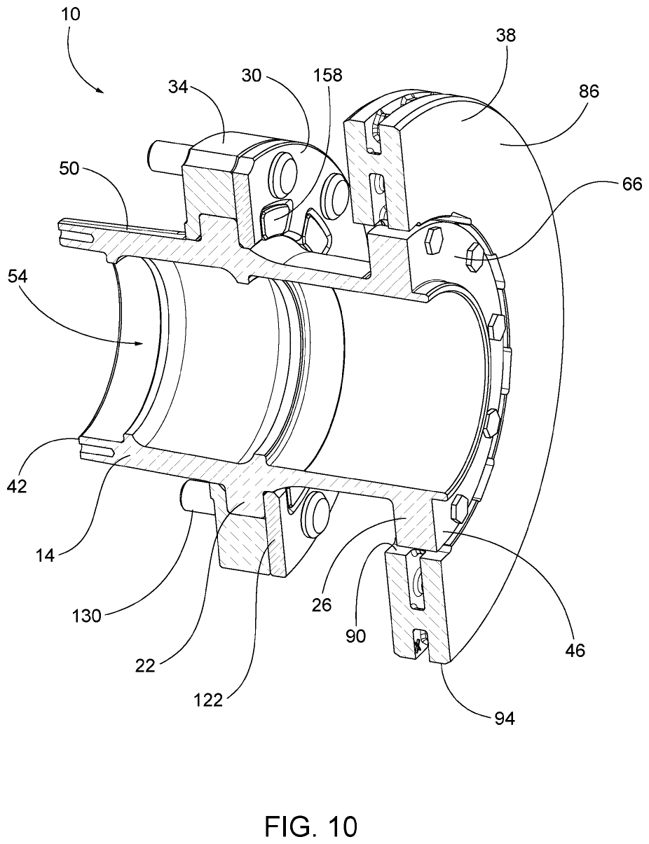

FIG. 8 illustrates how the locking ring 34 engages the wheel flange plate 30. As shown, the locking lugs 158 of the locking ring 34 can be inserted into gaps 134 defined between the adjacent lugs 122 of the wheel flange plate 30 when the stud apertures 126, 166 are aligned. Written another way, placing the stud apertures 166 of the locking ring 34 over the studs 130 positioned located the stud apertures 126 of the wheel flange plate 30 also aligns the locking lugs 158 with a gap 134 that the locking lugs 158 are sized and shaped to pass through. When the locking lugs 158 of the locking ring 34 are inserted into the gaps 134, the inner face 138 (specifically the outer annular portion 150 of the inner face 138) of the locking ring 34 abuts against a front face of the wheel flange plate 30, defining a plurality of radial pockets 174 between the locking ring 34 and wheel flange plate 30. The radial pockets 174 are sized and shaped to accept the lugs 22 of the hub 14. FIGS. 9-10 are cross-sections of the brake hub assembly 10 that illustrate the lugs 22 of the hub 14 positioned within the radial pockets 174. With reference once again to FIG. 8, in some embodiments, each of the locking ring 34 and wheel flange plate 30 include a respective marker or rotational position identifier 178, 182 that are aligned with one another when assembled in a particular rotational orientation.

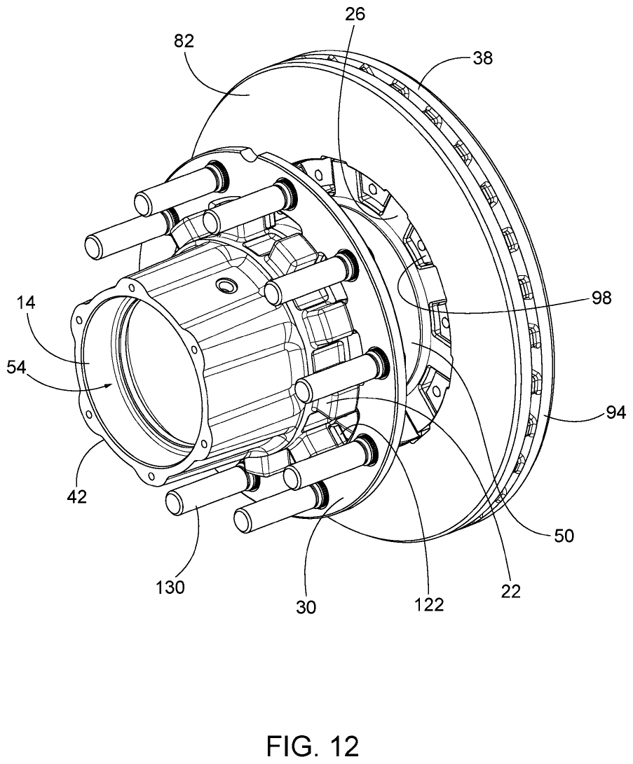

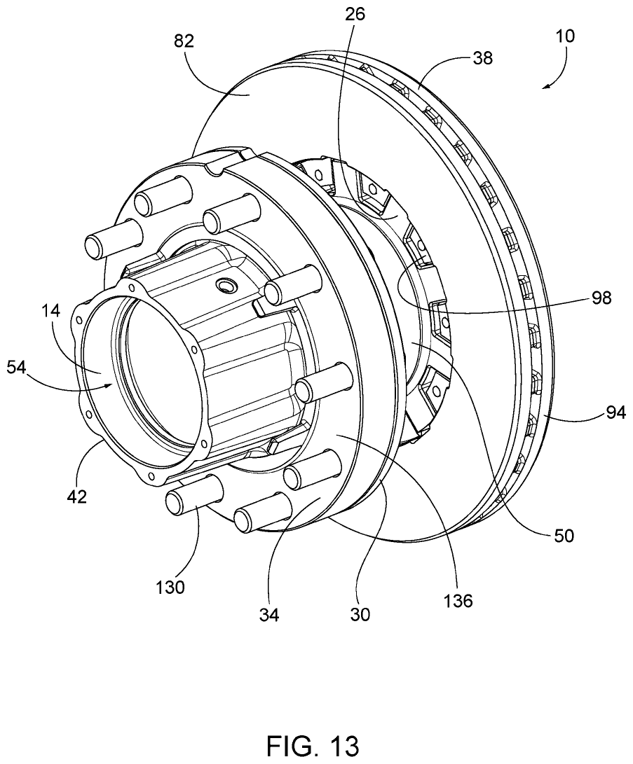

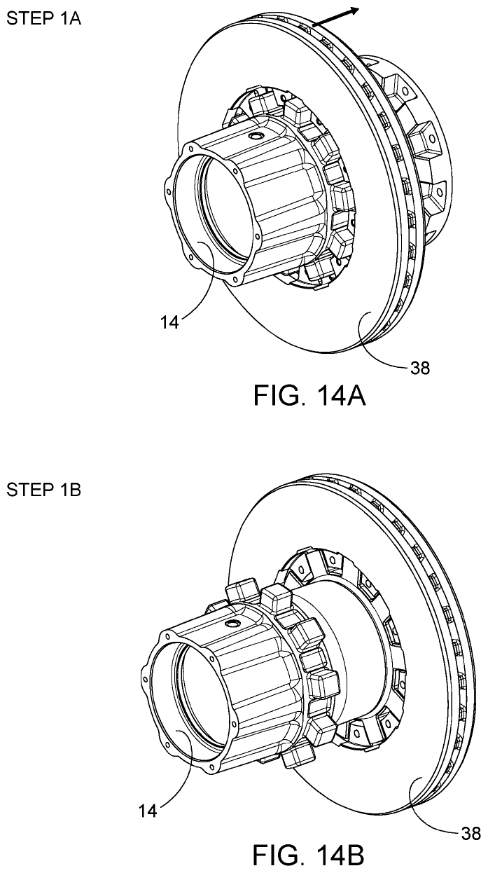

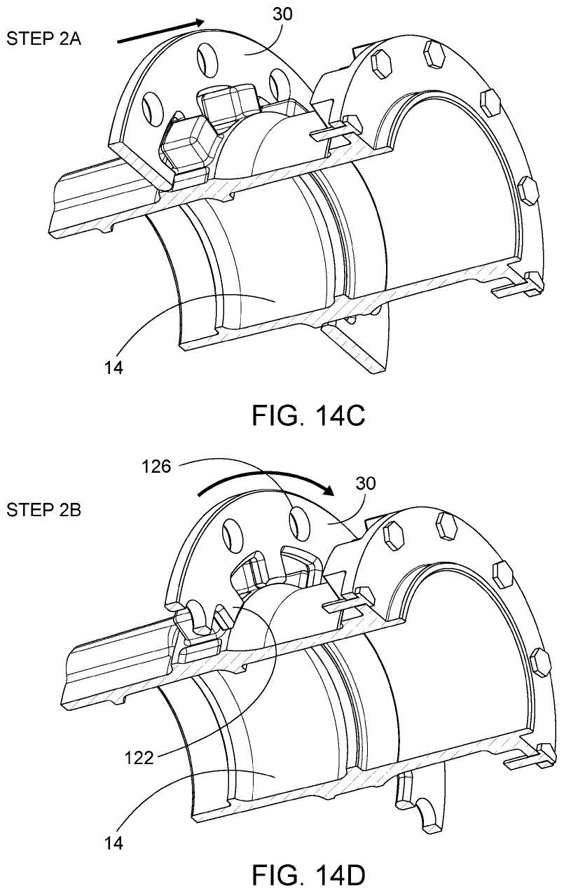

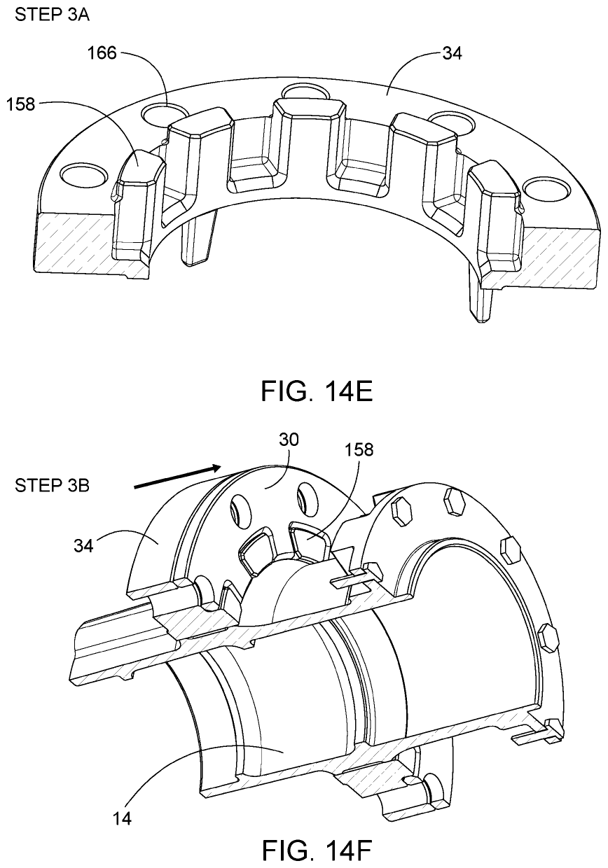

FIGS. 11-13 illustrate the brake hub assembly 10 in various states of assembly/disassembly. FIG. 11 illustrates the hub 14 with the brake disk 38 mounted to the hub via fasteners 74. FIG. 12 illustrates the hub 14 and brake disk 38 of FIG. 11 with the wheel flange plate 30 rotated into its operative position. FIG. 13 illustrates the hub 14, brake disk 38, and wheel flange plate 30 shown in FIG. 12 with the locking ring 34. FIGS. 14A-F includes an array of images that illustrate the assembly and disassembly of the brake hub assembly 10.

In operation, to install a brake disk 38 onto the wheel hub 14, a user passes the radially inner periphery 90 of the brake disk 38 over the first (outer) end 42 of the wheel hub 14, moving the brake disk 38 axially (in the direction of the axis 18) along the length of the wheel hub 14 towards the second (inner) end 46 of the hub 14. With reference to FIG. 14A, as the brake disk 38 approaches the first set of lugs 22, the user rotates the brake disk 38 (if not already appropriately aligned) such that the lugs 98 of the brake disk 38 pass through the gaps 62 defined between the lugs 22. Once past the lugs 22, as shown in FIG. 14B, the brake disk 38 is moved still further along the length of the hub 14 until the lugs 98 of the brake disk 38 are positioned within the gaps 70 between the second set of lugs 26 and the lugs 98 of the brake disk 38 axially abut against the rotor flange 66. The user fastens the brake disk 38 to the hub 14 via fasteners 74. The fasteners 74 are inserted through the apertures 78 in the rotor flange 66 and from there into the apertures 106 in the lugs 98 of the brake disk 98.

With the brake disk 38 fastened to the hub 14 as shown in FIG. 11, the wheel flange plate 30 is next added to the hub 14 to provide a mounting structure for a wheel to be mounted to the hub 14. In some embodiments, the studs 130 are coupled (e.g., fastened) to the wheel flange plate 30 prior to installation of the wheel flange plate 30 to the hub 14. To assemble the wheel flange plate 30, as shown in FIG. 14C, the user positions the central opening 118 of the wheel flange plate 30 around the first (outer) end 42 of the wheel hub 14, moving the wheel flange plate 30 axially along the length of the wheel hub 14 toward the second (inner) end 46 of the hub. Similar to the brake disk 38, as the wheel flange plate 30 approaches the first set of lugs 22, the user rotates the wheel flange plate 30 (if not already appropriately aligned) such that the lugs 122 of the wheel flange plate 30 pass through the gaps 62 defined between the lugs 22. Once past the lugs 22, as shown in FIG. 14D, the user rotates the wheel flange plate 30 relative to the hub 14 such that the lugs 122 axially abut a rear side of the lugs 22 and are not able to move axially towards the first (outer) end 42 of the wheel hub 14. The lugs 122 not only abut the lugs 22, they are also wholly moved out of alignment with the gaps 62 defined between the lugs 22 such that when viewed in the axial direction from the first end, the lugs 122 are entirely aligned with the lugs 22 and are hidden by the lugs 22 of the hub 14, as shown in FIG. 12. The wheel flange plate 30 is retained in this position during assembly of the locking ring 34. In some embodiments, a lip or backstop may hold the wheel flange plate 30 in the position shown in FIG. 12 and/or prevent further axial movement of the wheel flange plate 30 toward the second (inner) end 46 of the hub 14.

With the wheel flange plate 30 and associated studs 130 positioned on the hub 14 as shown in FIG. 12, the locking ring 34 (FIG. 14E) is next added to the hub 14 to prevent unwanted rotation of the wheel flange plate 30 relative to the hub 14. The user positions the central opening 142 of the locking ring 34 around the first (outer) end 42 of the wheel hub 14, moving the locking ring 134 axially along the length of the wheel hub 14 toward the second (inner) end 46 of the hub. As shown in FIG. 14F, the user aligns the stud apertures 166 of the locking ring 34 with the studs 130 and moves the locking ring axially along the studs 130 until the locking ring 34 axially abuts the wheel flange plate 30. When the locking ring 34 and wheel flange plate 30 are abutted, the locking lugs 158 of the locking ring 34 extend through the gaps 62 defined between adjacent lugs 22 of the hub 14 and also through the gaps 134 defined between adjacent lugs 98 of the wheel flange plate 30, thereby sandwiching the lugs 22 of the hub 14 between the locking ring 34 and the wheel flange plate 30. As the gaps 62, 98 are defined by adjacent lugs 22, 98, respectively, the locking lugs 158 engage adjacent lugs of the first set of lugs 22 of the brake hub 14 and engage adjacent lugs 98 of the wheel flange plate 30. In this arrangement, rotation of the hub 14 results in rotation of the wheel flange plate 30 and locking ring 34 (and a wheel mounted to the studs 130 of the wheel flange plate 30) based on the interaction between the lugs 22, 98, 158.

In operation, to remove the brake disk 38 from the wheel hub 14, the assembly operation provided above is carried out in an opposite order. Firstly, a wheel 200 (FIG. 15) is removed from the studs 130. Secondly, the locking ring 34 is axially moved away from the wheel flange plate 30, towards and over the first (outer) end 42 of the wheel hub 14. Thirdly, the wheel flange plate 30 is rotated out of abutment with the first set of lugs 22 of the wheel hub 14, such that the wheel flange plate 30 is moved through the gaps 62 defined between the lugs 22 toward and over the first (outer) end 42 of the wheel hub 14. Finally, with the wheel flange plate 30 removed, the brake disk 38 has the space required to remove the brake disk 38 over the first (outer) end 42 of the wheel hub 14, such that the hub 14 is not removed from the axle to remove the brake disk 38. The user removes the fasteners 74 coupling the brake disk 38 to the hub 14 and axially slides the brake disk 38 along the length of the hub 14, passing the lugs 98 through the gaps 62 between the lugs 22 of the hub 14 and removing the brake disk 38 over the first (outer) end 42 of the wheel hub 14.

What is claimed is:

1. A brake hub assembly attachable to an axle of a vehicle, the brake hub assembly comprising:
a hub defining a central axis, the hub having a first set of lugs extending radially outward away from the central axis and a second set of lugs axially spaced from the first set of lugs;
a wheel flange plate to which a wheel is securable, the wheel flange plate defining a first plurality of stud apertures and a set of flange plate lugs;
a locking ring defining a second plurality of stud apertures and having a set of locking lugs that are configured to engage adjacent lugs of the first set of lugs of the hub and adjacent lugs of the set of flange plate lugs such that the first and second plurality of stud apertures are axially aligned; and
a brake disk removably coupled to the second set of lugs;
wherein the wheel flange plate is positioned axially between the first set of lugs and the second set of lugs, and
wherein each of the wheel flange plate and the brake disk is removable from the hub without removing the hub from the axle.

2. The brake hub assembly of claim 1, wherein the first set of lugs includes a first number of lugs and the second set of lugs includes a second number of lugs, wherein the second number of lugs is greater than or equal to the first number of lugs.

3. The brake hub assembly of claim 1, wherein the hub extends between an outer end and an inner end, wherein each of the wheel flange plate and the brake disk is removable from the hub over the outer end without removing the hub from the axle, and wherein the first set of lugs is positioned at a location central between the outer end and the inner end.

4. The brake hub assembly of claim 3, wherein the second set of lugs is positioned at the inner end of the hub.

5. The brake hub assembly of claim 1, wherein each lug of the first set of lugs is radially aligned with a corresponding lug of the second set of lugs.

6. The brake hub assembly of claim 1, further comprising a rotor flange configured to engage an annular face of the brake disk when the brake disk is coupled to the second set of lugs.

7. The brake hub assembly of claim 6, wherein the rotor flange includes a plurality of openings, the brake hub assembly further comprising a plurality of fasteners, each fastener of the plurality of fasteners extending through a respective opening of the plurality of openings, the plurality of fasteners configured to fasten the brake disk to the hub.

8. The brake hub assembly of claim 1, wherein the wheel flange plate is an annular plate having a circular outer periphery and a central opening, wherein the central opening defines the set of flange plate lugs.

9. The brake hub assembly of claim 1, wherein the first set of lugs define a plurality of gaps between adjacent lugs of the first set of lugs, and wherein the set of flange plate lugs of the wheel flange plate are configured to extend through the plurality of gaps between adjacent lugs of the first set of lugs.

10. The brake hub assembly of claim 1, further comprising a plurality of studs, wherein each stud of the plurality of studs is configured to extend through the plurality of stud apertures of the wheel flange plate to support the wheel.

11. The brake hub assembly of claim 1, wherein the first set of lugs define a plurality of gaps between adjacent lugs of the first set of lugs, wherein the set of flange plate lugs define a plurality of gaps between adjacent lugs of the set of flange plate lugs, wherein the set of locking lugs are simultaneously positioned within the plurality of gaps between adjacent lugs of the first set of lugs and the plurality of gaps between adjacent lugs of the set of flange plate lugs.

12. The brake hub assembly of claim 1, wherein the wheel flange plate engages a first side of the first set of lugs, and wherein the locking ring engages a second side of the first set of lugs opposite the first side such that the first set of lugs is sandwiched between the wheel flange plate and the locking ring.

13. The brake hub assembly of claim 1, further comprising a plurality of axial protrusions extending axially outward from the locking ring and configured to guide installation of the wheel onto the hub.

14. The brake hub assembly of claim 1, wherein the locking ring includes an outer face and an inner face opposite the outer face, wherein the outer face defines a central opening that extends around the hub, wherein the inner face includes an outer annular portion and an inner annular portion, wherein the inner annular portion is located adjacent to the central opening and defines the set of locking lugs.

15. The brake hub assembly of claim 14, wherein the inner annular portion defines a plurality of locking pockets formed between adjacent lugs of the set of locking lugs, wherein the plurality of locking pockets receive the first set of lugs and the set of flange plate lugs.

16. A method of assembling a brake hub assembly, the method comprising:
inserting a brake disk in an axial direction over a first end of a hub, past a first set of lugs of the hub, and into engagement with a second set of lugs of the hub;
fastening the brake disk to the hub;
inserting a wheel flange plate over the first end of the hub and past the first set of lugs;
rotating a set of flange plate lugs of the wheel flange plate relative to the hub such that the wheel flange plate is precluded from axial movement towards the first end of the hub; and
inserting a locking ring over the first end of the hub such that locking lugs of the locking ring engage adjacent lugs of the first set of lugs and adjacent lugs of the set of flange plate lugs.

17. The method of claim 16, wherein inserting the locking ring over the first end of the hub includes sandwiching the first set of lugs between the locking ring and the wheel flange plate in the axial direction.

18. The method of claim 16, wherein engaging the locking lugs of the locking ring with adjacent lugs of the first set of lugs and the adjacent lugs of the set of flange plate lugs aligns stud apertures of the wheel flange plate with stud apertures of the locking ring, the method further comprising inserting studs through the stud apertures of the wheel flange plate and the stud apertures of the locking ring.

19. The method of claim 16, wherein the locking ring includes an outer face, an inner face substantially parallel to and axially offset from the outer face, and an inner annular portion substantially parallel to the outer face and located between the outer face and the inner face, wherein inserting the locking ring includes abutting the inner annular portion with the first set of lugs.

20. The method of claim 16, wherein rotating the set of flange plate lugs includes abutting an outer face of the wheel flange plate with the first set of lugs.
